(19) United States
(12) Patent Application Publication
(10) Pub. No.: US 2004/0236704 A1
(43) Pub. Date: Nov. 25, 2004

(54) Method and system for providing a compensation opportunity to a task candidate

(76) Inventor: Bradley L. Gotfried, Hobe Sound, FL (US)

Correspondence Address: AKERMAN SENTERFITT, P.O. BOX 3188, WEST PALM BEACH, FL, 33402-3188, US

(21) Appl. No.: 10/443,398

(22) Filed: May 22, 2003

(51) Int. Cl. G06F 17/60

(52) U.S. Cl. 705/400

(57) ABSTRACT

A method and system of providing a compensation opportunity to a task candidate for at least partially completing at least one task during transportation of the task candidate. The method includes the steps of collecting information about the task candidate to establish a profile for determining at least one task that the task candidate is eligible to perform, assigning to the task candidate the at least one task that passenger is eligible to perform and providing the task candidate compensation in exchange for at least partial completion of the at least one task. The method also includes the step of providing transportation to the task candidate.

### BACKGROUND OF THE INVENTION

1. Technical Field

The present invention relates to methods for efficient work arrangements, particularly to methods for providing work during transportation.

2. Description of Related Art

Many people travel to various places throughout this and other countries, whether it is for business or vacation. Certain forms of transportation may be quite lengthy. For example, cross-country airline flights, even at an advanced speed compared to other forms of travel, may exceed four hours in duration. Travel by car or train for such a cross-country distance is much longer.

Some individuals find ways to keep themselves occupied for at least a portion of the time spent traveling. Nevertheless, other travelers may not have anything to do or may run out of things to do during their trip. As a result, the time spent traveling on virtually all forms of transportation is unproductive for many individuals. Accordingly, there exists a need for a method and system for increasing the productivity of an individual's time spent traveling from one location to another.

### SUMMARY OF THE INVENTION

The present invention concerns a method of providing a compensation opportunity to a task candidate for at least partially completing at least one task during transportation of the task candidate. The method includes the steps of collecting information about the task candidate to establish a profile for determining at least one task that the task candidate is eligible to perform, assigning to the task candidate the at least one task that task candidate is eligible to perform and providing the task candidate compensation in exchange for at least partial completion of the at least one task. The method can also include the steps of providing transportation to the task candidate and establishing a profile for the task candidate.

In one arrangement, the compensation that is provided can include a reduced cost of transportation, a payment of a salary based at least in part on a predetermined time period or payment of a salary based at least in part on the assigned task. Alternatively, the providing compensation step can include issuing a compensation coupon where the compensation coupon can be redeemed later for compensation. As an example, the at least one compensation coupon can be an electronic coupon.

In another arrangement, the method can also include the step of at least one of a collecting entity, an assigning entity, a compensation providing entity, and a transportation providing entity receiving at least one compensation coupon. The entity that receives the at least one compensation coupon can provide compensation in exchange for receiving the at least one compensation coupon. Additionally, the method can include the step of at least one of a collecting entity, an assigning entity, a compensation providing entity, and a transportation providing entity receiving at least partially completed work on the at least one task.

In one embodiment, the method can include the step of at least one of a collecting entity, an assigning entity, a compensation providing entity, and a transportation providing entity selling at least a portion of a work segment. As an example, a work segment can be an amount of time required for completing at least a portion of the task. Additionally, the method can also include the step of selling a large volume of work segments at a reduced selling price. In still another arrangement, the method can include the step of providing a work device for facilitating at least a partial completion of the at least one task.

The present invention also concerns a system for providing a compensation opportunity to a task candidate for at least partially completing at least one task during transportation of the task candidate. The system includes an information collector in which the information collector collects information about the task candidate to establish a profile for determining the at least one task that the task candidate is eligible to perform, a task assignor in which the task assignor assigns to the task candidate the at least one task that the task candidate is eligible to perform and a compensation provider in which the compensation provider provides the task candidate compensation in exchange for at least partial completion of the at least one task.

The system can also include a transporter in which the transporter can provide transportation to the task candidate. Additionally, the information collector, the task assignor, the compensation provider and the transporter are at least one of distinct entities, a single entity, and a combination therein. Also, the system can be accessible through a communications network.

### BRIEF DESCRIPTION OF THE DRAWINGS

FIG. 1. illustrates a diagram of a system for providing a compensation opportunity to a task candidate for at least partially completing one or more tasks during transportation of the task candidate in accordance with the inventive arrangements.

FIG. 2. illustrates a communications network and several components connected to the communications network in accordance with the inventive arrangements.

FIG. 3. illustrates a flow chart of a method for providing a compensation opportunity to a task candidate for at least partially completing one or more tasks during transportation of the task candidate in accordance with the inventive arrangements.

### DETAILED DESCRIPTION OF THE PREFERRED EMBODIMENTS

In accordance with the inventive arrangements, a method and a system for providing a compensation opportunity to a task candidate for at least partially completing one or more tasks during transportation of the task candidate is provided. For purposes of the invention, a task candidate can be any individual from whom information can be collected in which the information is processed to determine whether the individual is capable of performing a specific task. As an example, a task candidate can be a passenger traveling on any type of transportation or a potential passenger who may travel at a later date.

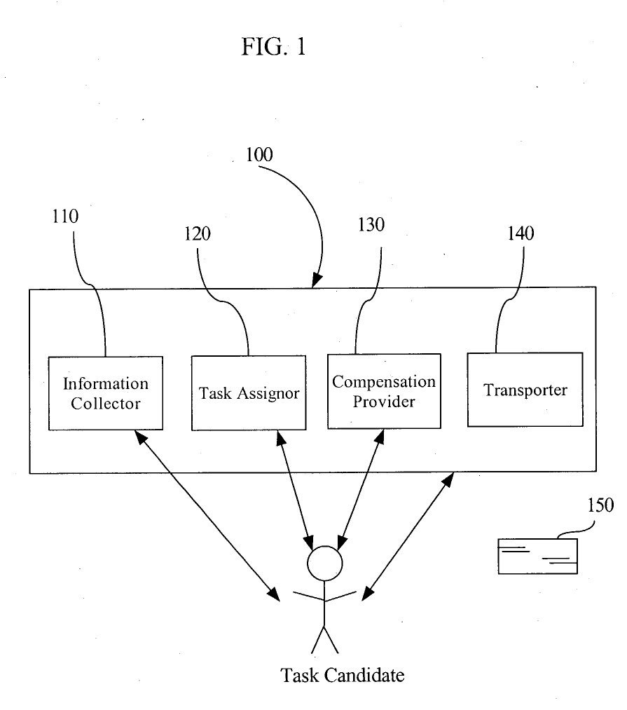

Referring to the diagram in FIG. 1, a system 100 for providing a compensation opportunity to a task candidate for at least partially completing one or more tasks during transportation of the task candidate is shown. The system 100 can include an information collector 110, a task assignor 120, and a compensation provider 130. The information collector 110 can collect information about the task candidate to establish a profile for determining the one or more tasks that the task candidate is eligible to perform. The information that the information collector 110 obtains can be acquired directly from the task candidate or can be retrieved from a database containing information relating to the task candidate. Based on the information acquired by the information collector 110, the task assignor 120 can assign to the task candidate the one or more tasks that the task candidate is eligible to perform. In addition, the task assignor 120 can sell the time to be spent by task candidates for performing their assigned tasks. As an example, the work time can be sold to any type of individual or company in need of having work performed. The compensation provider 130 provides the task candidate compensation in exchange for at least a partial completion of the one or more tasks.

In one embodiment, the system 100 can also include a transporter 140 that can provide transportation to the task candidate. The transporter 140 can be any service that operates vehicles (including railway vehicles), vessels, or aircraft capable of transporting one or more persons from one location to another. Without limitation, suitable examples include commercial airlines, commercial bus lines, commercial shipping lines, and commercial rail lines.

It should be noted that the information collector 110, the task assignor 120, the compensation provider 130, and the transporter 140 can be distinct entities, a single entity or a combination thereof. For example, the information collector 110 can be the same entity as the compensation provider 130, while a different entity can be the task assignor 140. In another embodiment, the information collector 110, the task assignor 120, the compensation provider 130, and the transporter 140 can all be the same entity. Nevertheless, the invention is not limited in this regard, as one skilled in the art will appreciate the numerous possible combinations of entities that can exist.

In one arrangement, the information collector 110 can be a computer loaded with software suitable for collecting information about one or more task candidates. For example, task candidates can enter into the computer information such as type of occupation, years of experience in the occupation and types of degrees earned or the discipline currently being pursued if the task candidate is a student. Of course, the invention is not limited in this regard, as the information collector 110 can acquire other suitable forms of information, even from pre-existing databases. In addition, the information collector 110 is not limited to being a computer, as the information collector 110 can be a human. In this arrangement, the human information collector 110 can distribute forms seeking information from task candidates and can collect these forms once the task candidates answer the inquires contained thereon.

If the information collector 110 is a computer, the task assignor 120 can be, for example, a software application loaded into the information collector 110 for assigning one or more tasks to one or more task candidates. Additionally, the software application can also process the information collected by the information collector 110 and can sell time to be spent by the task candidates when performing tasks. Alternatively, the task assignor 120 can be a separate computer loaded with software suitable for assigning tasks to task candidates and, perhaps, selling work time. The task assignor 120 can also be a human trained to assign tasks to task candidates based on the collected information and possibly to conduct transactions based on the sale of work time.

For example, if the information about a task candidate collected by the information collector 110 indicates that the task candidate is employed in the accounting profession, the task assignor 120 can assign a task to the task candidate that requires skills that are commensurate with the training and education that an accountant receives. The task assignor 120 can also offer for sale the time to be spent by the accountant in completing the assigned task. Alternatively, the task assignor 120 can sell at a flat rate the work to be performed by the accountant. It is understood, however, that the invention is in no way limited to this particular example, as there are a myriad of skills held by task candidates that the task assignor 120 can consider for purposes of assigning tasks and selling work time. Moreover, the information collector 110, the compensation provider 130 and the transporter 140 can also perform the selling step described above.

In one arrangement, the compensation provider 130 can be a computer loaded with software capable of receiving at least partially completed tasks from the task candidate and dispensing compensation based on such tasks. As an example, a task candidate can enter into the computer information or answers to inquiries relating to the assigned task. Alternatively, the task candidate can provide an electronic version of the at least partially completed task to the computer. Based on the amount and/or the quality of the information or answers relating to the task that the compensation provider 130 receives, the compensation provider 130 can calculate an appropriate compensation for the task candidate. The compensation provider 130 can also be a human trained to evaluate the tasks completed by the task candidates and to determine an appropriate compensation. Examples of compensation and how it may be dispensed will be discussed below.

In an alternative arrangement, the transporter 140 can receive the at least partially completed task. The transporter 140 can then determine the appropriate amount of compensation to be provided to the task candidate by the compensation provider 130. As such, and similar to the compensation provider 130, the transporter 140 can include computers loaded with suitable software for evaluating information or answers to inquires relating to the assigned task. Additionally, the transporter 140 can include humans trained to do the same. Once the appropriate compensation is determined, the transporter 140 can issue compensation or a compensation coupon 150. The compensation provider 130 can include software or can be trained for dispensing compensation in exchange for the compensation coupon 150, which can be redeemed immediately or at a later date. It is also possible for an entity other than the transport 140 to dispense compensation coupons 150 to be redeemed by the compensation provider 130.

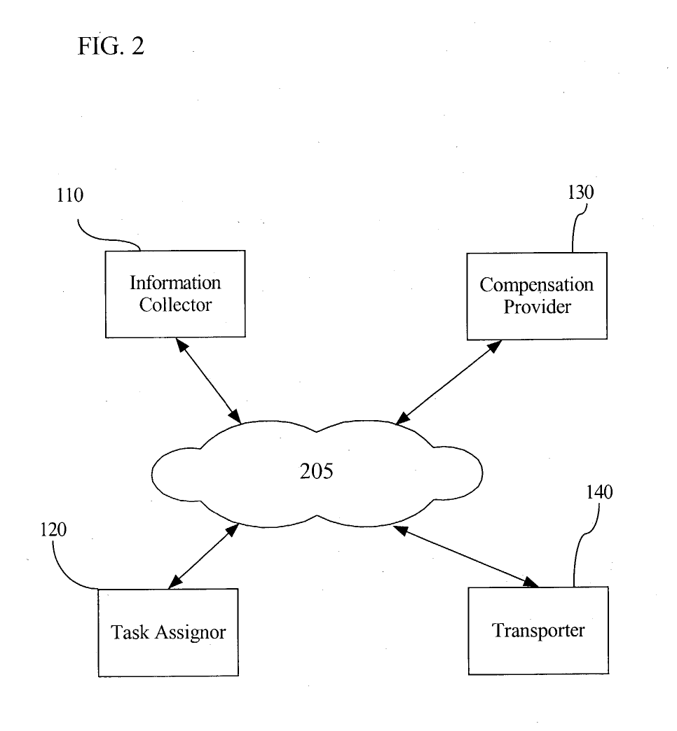

In another embodiment, as shown in FIG. 2, the system 100 can be accessible through a communications network 205. A communications network 205 can be any network that allows for the transfer of data between the any number of locations connected to the network. As an example, the communications network 205 can be the Internet, an intranet or a local area network (LAN). Those of ordinary skill, however, will appreciate that the communications network 205 is in no way limited to these particular examples. In either arrangement, the information collector 110, the task assignor 120, the compensation provider 130, and the transporter 140 can all be accessible through the communications network 205.

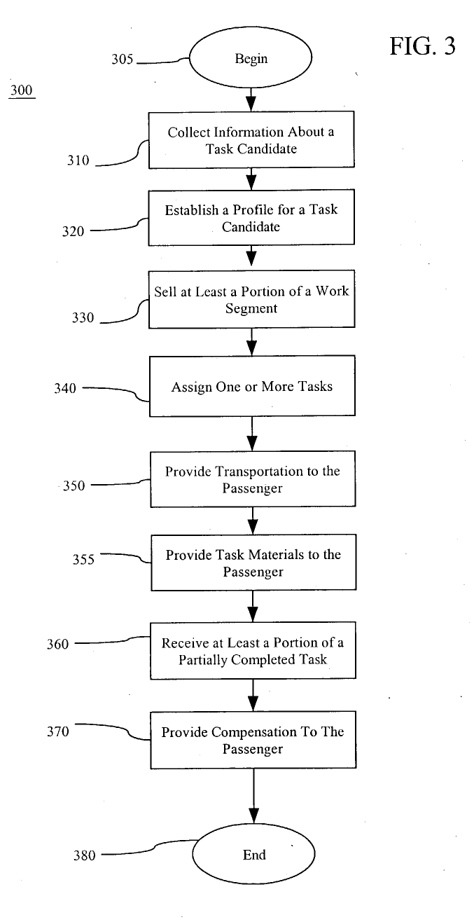

Referring to FIG. 3, a method 300 of providing a compensation opportunity to a task candidate for at least partially completing one or more tasks during transportation of the task candidate in accordance with the inventive arrangements is shown. Before discussing the method 300, it should be noted that there is no particular order for completing the illustrated steps. Additionally, although many steps can be included in method 300, all steps are not necessary, as several of them are optional in accordance with the inventive arrangements.

The method 300 can begin at step 305. At step 310, information can be collected about the task candidate to establish a profile for determining one or more tasks that the task candidate is eligible to perform. This collection of information can ensure that the task candidate is assigned a task that corresponds to the skills held by the task candidate. The information that is collected can include any information that is relevant to the ability of a task candidate to perform a task. Examples include the task candidate's profession, computer proficiency, level of education, and languages spoken by the task candidate; however, the invention is not limited in this regard, as other suitable forms of information relating to a task candidate can be garnered to establish a profile for the task candidate.

For purposes of the invention, if a task candidate has the ability to perform a task, the task candidate can be considered eligible to perform that task; however, the ability of the task candidate to perform a task will not always result in such a task candidate being eligible to perform that task. As an example, while an English professor may be able to review and critique a legal brief for such things as grammar and sentence structure, an English professor is not a lawyer, and therefore, is not eligible to perform work relating to the practice of law. Other safeguards may be implemented to curtail ill-assigned tasks or even abuse. For example, if it is determined that a task candidate is a lawyer, information such as the state bar number of the attorney can be collected to ensure that the lawyer task candidate is in good standing and licensed to practice in a particular jurisdiction.

Information about a task candidate can be acquired in a variety of ways. In one embodiment, information can be collected through the use of a communications network, such as the Internet (see FIG. 2). For example, a task candidate may answer questions or enter information through a Website. Collecting information through the Internet may provide the advantages of compiling the information in a database for easily accessing and recording the information to a storage medium. Nevertheless, the invention is not limited to the collection of information through the Internet, as information can also be obtained through phone interviews, paper forms, and the like. It should also be noted that the collection of information is not limited to gathering data that is provided by the task candidate, as discussed above. Information can also be collected about task candidates through public records and/or non-public sources.

With the information collected about a task candidate, a profile for the task candidate can be established, as shown in step 320. The profile can include many things, such as a listing of all the information collected in the collecting step 310. The profile can be established to facilitate and increase the efficiency of assigning one or more tasks to the task candidate. For example, with a profile established for a particular task candidate, future task assignments can be based on the task candidate's profile, instead of repeating the collecting step 310. Additionally, the profile can be established to characterize the type of tasks a task candidate may be eligible to perform. For example, a task candidate who is a chemical engineer can be characterized as being eligible to perform work related to chemical engineering.

At step 330, at least a portion of a work segment can be sold. The buyer of a work segment can be an entity that wishes to have work performed by qualified task candidates. Without limitation, examples of such an entity include accounting firms, law firms, universities and government agencies. For purposes of the invention, a work segment can be the amount of time required to complete at least a portion of a task assigned to a task candidate. Large volumes of work segments can be sold at a reduced selling price. The work segment can be an estimate of the amount of time for completing at least a portion of the task or an actual amount of time for completing at least a portion of the task. As such, the work segments can be sold prior to or subsequent to the task candidate performing the assigned task. In an alternative arrangement, a work segment can be an actual task that will be assigned to a task candidate in which the selling price is based primarily on the work associated with the task, not the amount of time required to complete the task.

Moving to step 340, the task candidate can be assigned one or,more tasks that the task candidate is eligible to perform. The task assigning step 340 can be based on the profile for the task candidate established in step 320; however, the basis for assigning such tasks is not limited to the profile established in step 330, as other processes may be used to assign tasks to task candidates.

In one embodiment, the task assigning step 340 can include notifying the task candidate of the task assignment designation and providing the task candidate with the task for completion. As an example, a task candidate can be notified of the task assignment designation through any mode of communication, such as by telephone, e-mail, text message, or an Internet posting. The task candidate can also be notified when receiving the one or more tasks to be completed, such as when the task candidate receives the actual tasks to be completed. Additionally, the task candidate can be provided with the one or more tasks to be completed via an attachment in an e-mail or by downloading it from a Website. Such an arrangement may provide the advantages of eliminating the transferring of paper documents from one location to another.

In one embodiment, at the option of the task candidate, the task candidate can be provided with transportation, as shown in step 350. The transportation provided to the task candidate can include any form of transportation, such as air, sea, bus, and train transportation; however, the invention is not limited to the examples listed as the transportation can be any suitable form of transportation. The transportation can ferry the task candidate to any desired location and can allow the task candidate to perform work on one or more tasks during the transportation. It is understood, however, that the task candidate is not limited to performing the task as he or she travels, as a task can be completed during any other time available to the task candidate.

At step 355, the task candidate can also be provided with task materials, which may facilitate the performance of the task candidate in completing the assigned task. Task materials can include any materials or devices that can be used by the task candidate to execute the assigned task. Suitable examples include pencils, pens, paper, calculators, personal computers, network computers, or personal digital assistants; however, the invention is not limited in this regard, as any other materials or devices can serve as task materials.

In one arrangement, the task materials can be integrated into the vehicle, vessel, aircraft, railway car, etc., in which the task candidate will travel. For example, if the task candidate is provided with air transportation, a task device can be integrated into the back of a seat on the aircraft, such as a fold-down computing device. Such integration can provide the task candidate with a comfortable work environment for completing the assigned task.

Once a task candidate has completed at least a portion of the assigned task, the task can be received, as shown in step 360. In a preferred embodiment, completed tasks are received in step 360; however, the invention is not limited in this regard, as partially completed tasks can also be received. In some instances, receiving an uncompleted task or a partially completed task can be advantageous and even necessary. For example, if a first task candidate completes one-half of a task, such as proofreading the first half of an essay, a second task candidate can complete the other half of the task, which, in this instance, is proofreading the remainder of the essay.

At step 370, a task candidate can be provided with compensation in exchange for at least partial completion of the task. For example, the compensation provided to a task candidate can include a reduced cost of transportation. The reduced cost of transportation can include reducing the cost of transportation so that the task candidate only pays a percentage of the full cost of the transportation. The reduced cost of transportation can also include reducing the cost of transportation to zero so that the task candidate does not have to pay for the transportation. In this arrangement, the cost of transportation can be reduced by providing a transportation ticket to the task candidate prior to travel, such as a train ticket, reimbursing the task candidate for the expense associated with the travel or through any other suitable process.

Another example of compensation includes the payment of a salary based on a predetermined time period or based on an assigned task. For example, a task candidate can be compensated with a salary in which the salary is calculated, at least in part, in view of the number of hours or other suitable temporal durations that the task candidate spends on a particular task. Alternatively, a task candidate can be compensated with a predetermined compensation in which the predetermined compensation is based primarily on the type of task involved; the amount of time spent on the task is not crucial to the determination of this type of compensation. In either arrangement, calculation of the compensation can be based on a variety of factors, including information collected about the task candidate, the profile established for the task candidate or the complexity of the task assigned to the task candidate. It should be noted that the invention is not limited in this regard, as this list of factors is not exhaustive.

Another example of compensation that can be provided includes a compensation coupon in which the coupon can be redeemed later for a cash or check payment or any type of goods or services. The compensation coupon can be any form of authentication indicating that the task candidate is entitled to the compensation designated by the coupon. The compensation coupon can be in many different forms. Examples include a paper coupon, a prepaid charge card or an electronic coupon in the form of an e-mail. It is understood, however, that the invention is not limited to these particular examples, as the compensation coupon can be disbursed through any other suitable process.

While several examples of suitable compensation have been illustrated above, it must be noted that the invention is not so limited. The compensation to be provided can be any incentive, reward or payment. Finally, at step 380, the method 300 can end.

To illustrate some of the potential benefits of the invention, an example will be presented in which a task candidate interacts with the system 100 of FIG. 1 in accordance with the inventive method 300 set forth in FIG. 3. In the following example, the information collector 110, the task assignor 120, the compensation provider 130, and the transporter 140 will all be the same entity; however, it should be noted that such an arrangement of system 100 is only an example, and the information collector 110, the task assignor 120, the compensation provider 130, and the transporter 140 can be discrete entities. Additionally, a number of the steps of method 300 have been omitted for purposes of explaining this particular example. For purposes of the example, the task candidate may be a certified public accountant (“CPA”).

The task candidate may have a weekly commute of flying four hours each way, to and from a place of residence and a place of work. Accordingly, the transporter 140 can be a commercial airline. The task candidate spends a total of eight hours commuting each week. In accordance with the inventive arrangements, this commuting time may be devoted to the completion of a task. The information collector 110 can collect information (step 310) that is relevant to the ability of the task candidate to perform a task. Here, the task candidate may provide information to the information collector 110 through a Website, including the fact that he or she is a CPA. With this information, the information collector 110 can establish a profile of the task candidate (step 320) for determining one or more tasks that the task candidate is eligible to perform.

With a profile established, the task assignor 120 can sell (step 330) to a third party at least a portion of a work segment based on the profile of the task candidate. For example, the task assignor 120 can contact an accounting firm and offer the services of the CPA for approximately four hours. The accounting firm may wish to have the CPA prepare several tax returns and can pay the task assignor 120 a fee to complete the transaction. In this instance, the fee can be based on the number of tax returns to be completed and their complexity.

In response, the task assignor 120 can assign (step 340) to the CPA task candidate the task that the CPA task candidate is eligible to complete, i.e., the tax returns. In this example, the task assignor 120 can transmit to the CPA task candidate notification of the task through an e-mail. Additionally, the task assignor 120 can transmit to the CPA task candidate the tax returns to be completed and their associated documents as an attachment to the e-mail. The CPA task candidate can bring an electronic copy of the attachment or a printout of the attachment for use during his or her commute. Alternatively, the task assignor 120 can provide to the CPA task candidate the materials associated with the tax returns during the checking procedure at the airport, or even while boarding the plane.

During the transportation provided (step 350) by the transporter 140, the CPA task candidate can work on the assigned task during the four hours of one leg of the weekly commute. In this example, the transporter 140 may also provide (step 355) a task material to the CPA task candidate, such as a laptop computer or a calculator. Working the four hours on the task to be completed allows the CPA task candidate to earn valuable compensation during time that may have otherwise been unproductive. When the CPA task candidate completes the tax returns, or when the trip is completed, he or she can deliver the at least partially completed tax returns to the compensation provider 130. In this example, because the information collector 110, the task assignor 120, the compensation provider 130, and the transporter 140, are the same entity, the at least partially completed task can be received (step 360) by a flight attendant, for example, who represents the transporter 140.

In return for at least partially completing the assigned tasks, the compensation provider 130, who again may be represented by a flight attendant, can provide (step 370) the CPA task candidate with compensation. In this example, the compensation can include a check for the amount that the CPA task candidate paid for the transportation. Such an arrangement allows the CPA task candidate to use the time during the commute to earn enough compensation to pay for the commute. It should be noted that the above example is merely illustrative of the benefits and advantages of system 100 and method 300. The invention is not limited by the above example, as the invention has a multitude of variations not discussed in the illustration.

Although the present invention has been described in conjunction with the embodiments disclosed herein, it should be understood that the foregoing description is intended to illustrate and not limit the scope of the invention as defined by the claims.

What is claimed is:

1. A method of providing a compensation opportunity to a task candidate for at least partially completing at least one task during transportation of the task candidate, comprising the steps of:
collecting information about the task candidate to establish a profile for determining at least one task that the task candidate is eligible to perform;
assigning to the task candidate the at least one task that the task candidate is eligible to perform; and
providing the task candidate compensation in exchange for at least partial completion of the at least one task.

2. The method according to claim 1, further comprising the step of providing transportation to the task candidate.

3. The method according to claim 1, further comprising the step of establishing a profile for the task candidate.

4. The method according to claim 1, wherein the compensation that is provided comprises a reduced cost of transportation.

5. The method according to claim 1, wherein the compensation that is provided comprises a payment of a salary based at least in part on a predetermined time period.

6. The method according to claim 1, wherein the compensation that is provided comprises payment of a salary based at least in part on the assigned task.

7. The method according to claim 1, wherein said providing compensation step comprises issuing a compensation coupon;
wherein said compensation coupon can be redeemed later for compensation.

8. The method according to claim 7, wherein the at least one compensation coupon is an electronic coupon.

9. The method according to claim 7, further comprising the step of at least one of a collecting entity, an assigning entity, a compensation providing entity, and a transportation providing entity receiving at least one compensation coupon;
wherein the entity that receives the at least one compensation coupon provides compensation in exchange for receiving the at least one compensation coupon.

10. The method according to claim 2, further comprising the step of at least one of a collecting entity, an assigning entity, a compensation providing entity, and a transportation providing entity receiving at least partially completed work on the at least one task.

11. The method according to claim 1, further comprising the step of at least one of a collecting entity, an assigning entity, a compensation providing entity, and a transportation providing entity selling at least a portion of a work segment.

12. The method according to claim 11, wherein the work segment is an amount of time required for completing at least a portion of the task.

13. The method according to claim 11, further comprising the step of selling a large volume of work segments at a reduced selling price.

14. The method according to claim 1, further comprising the step of providing a work device for facilitating a least a partial completion of the at least one task.

15. A system for providing a compensation opportunity to a task candidate for at least partially completing at least one task during transportation of the task candidate, comprising:
an information collector, wherein said information collector collects information about said task candidate to establish a profile for determining said at least one task that said task candidate is eligible to perform;
a task assignor, wherein said task assignor assigns to said task candidate said at least one task that said task candidate is eligible to perform; and
a compensation provider, wherein said compensation provider provides said task candidate compensation in exchange for at least partial completion of said at least one task.

16. The system according to claim 15, further comprising a transporter; wherein said transporter provides transportation to said task candidate.

17. The system according to claim 16, wherein said information collector, said task assignor, said compensation provider, and said transporter are at least one of distinct entities, a single entity, and a combination thereof.

18. The system according to claim 15, wherein said system is accessible through a communications network.
